(19) United States
(12) Patent Application Publication
(10) Pub. No.: US 2010/0242047 A1
(43) Pub. Date: Sep. 23, 2010

(54) DISTRIBUTED PROCESSING SYSTEM, CONTROL UNIT, AND CLIENT

(75) Inventors: Mitsunori Kubo, Tokyo (JP); Arata Shinozaki, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/727,756

(22) Filed: Mar. 19, 2010

(30) Foreign Application Priority Data
Mar. 19, 2009 (JP) 2009-067614

(51) Int. Cl. G06F 9/46; G06F 15/173

(52) U.S. Cl. 718/104; 709/223; 718/100

(57) ABSTRACT

A distributed processing system includes a client that makes a request for execution of a service requested by a user, a processing element, a control unit connected with the client and the processing element. The control unit has control functions for controlling the distributed processing system, and the client has at least one control function that is same as one of the control functions of the control unit. With respect to at least one control function that both the control unit and the client have, at least one of the control function of the control unit and the control function of the client is selected to execute a control.

### CROSS-REFERENCE TO RELATED APPLICATION

The present application is based upon and claims the benefit of priority from the prior Japanese Patent Application No. 2009-067614 filed on Mar. 19, 2009; the entire contents of which are incorporated herein by reference.

### BACKGROUND OF THE INVENTION

1. Field of the Invention

The present invention relates to a distributed processing system, a control unit, and a client.

2. Description of the Related Art

In a system control in a parallel processing system, a task scheduling is performed by dividing a given service into appropriate tasks, assigning the tasks to discrete computational resources, and matching the output and the input. In some cases, a sub-process is reassigned, terminated, or restarted based on the dynamic status of computation modules obtained during task execution.

With the above-described control, the efficiency of processing can be increased by distributing the load and optimizing power consumption. A parallel processing system to which such a system control function is applied is disclosed for example in Japanese Patent Application Laid-Open No. 2002-7364. In the parallel processing system, a large variety of control functions such as registration and management of computational modules are needed in addition to the scheduling of tasks.

### SUMMARY OF THE INVENTION

A distributed processing system according to the present invention comprises a client that makes a request for execution of a service requested by a user, a processing element, and a control unit connected with the client and the processing element, wherein the control unit has control functions for controlling the distributed processing system, the client has at least one control function that is same as one of the control functions of the control unit, and with respect to at least one control function that both the control unit and the client have, at least one of the control function of the control unit and the control function of the client is selected to execute a control.

A distributed processing system according to another aspect of the present invention comprises a client that makes a request for execution of a service requested by a user, and a processing element connected with the client, wherein the distributed processing system is controlled only by a control function that the client has.

A distributed processing system according to still another aspect of the present invention comprises a control unit having a function of accepting the entry of a service request by a user, and a processing element connected with the control unit, wherein the distributed processing system is controlled only by a control function that the control unit has.

A control unit according to the present invention constitutes a distributed processing system together with a client that makes a request for execution of a service requested by a user and a processing element, and has control functions for controlling the distributed processing system, wherein with respect to at least one of control functions that both the control unit and the client have, at least one of the control function of the control unit and the control function of the client is selected to execute a control.

A client according to the present invention is connected to a control unit having control functions for controlling a distributed processing system, makes a request for execution of a service requested by a user, and has at least one control function that is same as one of the control functions of the control unit, wherein a control is executed using a control function selected by the control unit with respect to at least one control function that both the control unit and the client have.

### BRIEF DESCRIPTION OF THE DRAWINGS

FIG. 1 is a diagram showing an exemplary configuration of a distributed processing system according to an embodiment of the present invention.

FIG. 2 is a flow chart showing a flow of a process of an application according to the embodiment of the present invention.

FIG. 3 is a table showing the correspondence between the service and the tasks that constitutes the service shown in FIG. 2.

FIG. 4 is a table showing exemplary items of information constituting the execution transition information and exemplary data of the respective items of the information.

FIG. 5 is a diagram showing an exemplary model of a system corresponding to the configuration specified by the execution transition information shown in FIG. 4.

FIG. 6 is a table showing examples of control functions used in the distributed processing system according to the embodiment of the present invention.

FIG. 7 is a table showing a first example of the selective setting of control functions.

FIG. 8 is a table showing a second example of the selective setting of control functions.

FIG. 9 is a table showing a third example of the selective setting of control functions.

FIG. 10 is a table showing a fourth example of the selective setting of control functions.

FIG. 11 is a table showing a fifth example of the selective setting of control functions.

FIG. 12 is a diagram showing examples of policy IDs and their status in scheduling policy management.

FIG. 13 is a table showing an example of PE basic information and status in PE information management.

FIG. 14 is a process flow diagram showing a process in a case in which all of the control functions are assigned to the control unit, in the selective setting.

FIG. 15 is a process flow diagram showing a process in a case where some control functions are assigned to a client, and the other control functions are assigned to the control unit, in the selective setting.

FIG. 16 is a process flow diagram showing a process in a case all of the control functions are assigned to the client, in the selective setting.

FIG. 17 is a flow chart showing a process of forced change of selection by a control command.

FIG. 18 is a flow chart showing a process of the forced change of selection according to a changing condition.

### DETAILED DESCRIPTION OF THE INVENTION

In the following, embodiments of the distributed processing system, the control unit, and the client according to the present invention will be described in detail with reference to the accompanying drawings. It should be understood that the present invention is not limited to the embodiments.

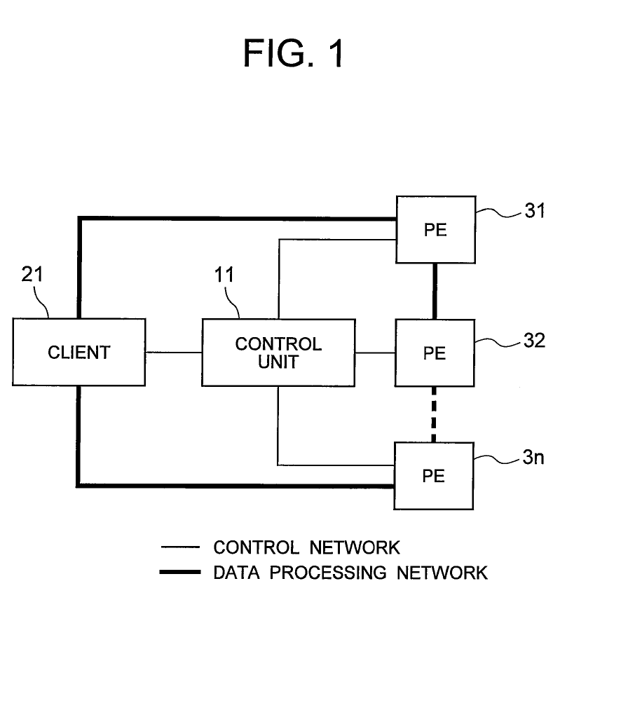

First, a processing model according to an embodiment will be described with reference to FIG. 1. FIG. 1 is a diagram showing an exemplary configuration of the distributed processing system according to the embodiment.

As shown in FIG. 1, the distributed processing system includes a client 21 that makes a request for execution of an application (or service), a control unit 11 (which will be hereinafter referred to as CU in some cases) that controls the entire system, and processing elements 31 to 3n (which will be hereinafter referred to as PE in some cases) that serve as computation modules. The client 21 is a kind of processing element and may perform computations.

An ID used to identify the processing element will be referred to as a PEID. The processing element has a specialized function for task processing. An ID used to identify this function will be referred to as a function ID.

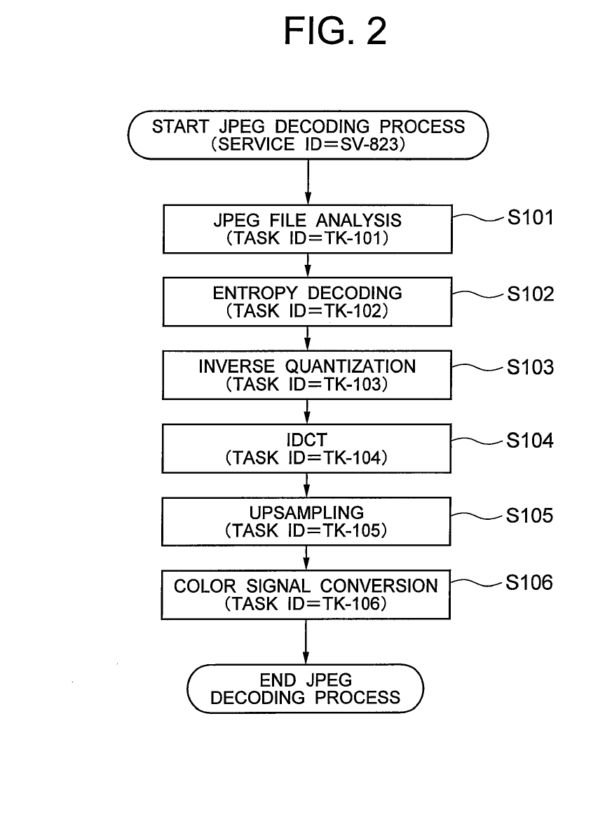

An example of the execution of an application will be described with reference to FIG. 2. FIG. 2 is a flow chart showing the flow of the processing of an application. Here, a JPEG decoding process will be discussed by way of example.

The JPEG decoding process can be divided into six sequential processes, namely JPEG file analysis (step S101), entropy decoding (step S102), inverse quantization (step S103), IDCT (step S104), upsampling (step S105), and color signal conversion (step S106), as shown in FIG. 2.

An application, such as the JPEG decoding process, requested by a user to be executed will be referred to as a service. A sub-process, such as the entropy decoding, that constitutes a part of the JPEG decoding process, will be referred to as a task.

A unique service ID and a unique task ID are assigned to each service and each task respectively in order to identify the content of their processing. Here, the service ID of the JPEG decoding process is SV-823 and the task IDs of the tasks that constitute the JPEG decoding process are TK-101 to TK-106.

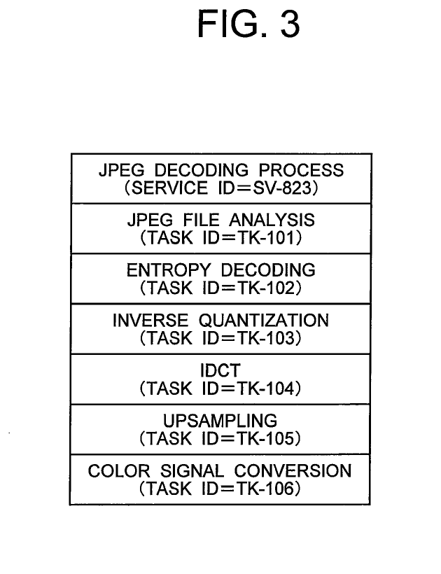

As a request for the execution of the JPEG decoding process or service is made by the client 21, the control unit 11 divides the JPEG decoding process, for example, into a sequence of tasks TK-101 to TK-106 in accordance with a service-task correspondence table shown in FIG. 3. FIG. 3 is a table specifying the correspondence between the service and the tasks shown in FIG. 2.

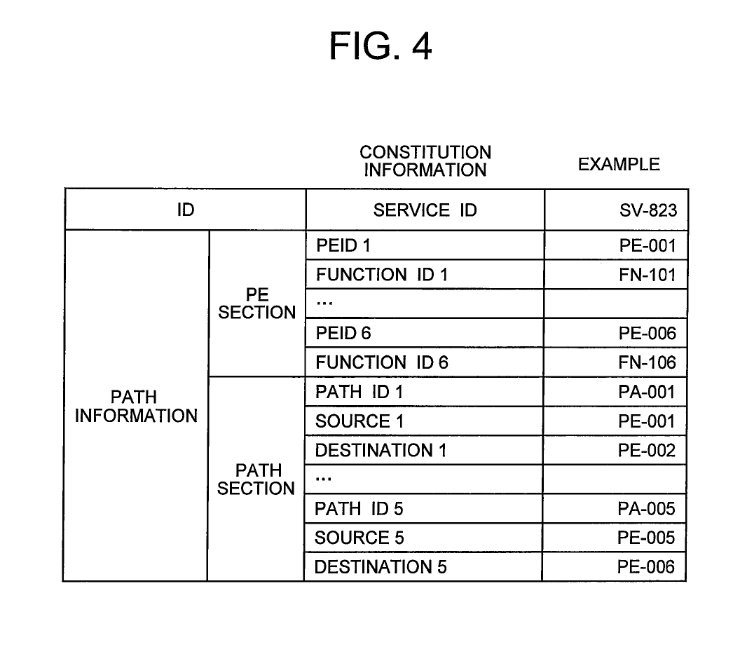

The tasks are assigned to the processing elements that can execute the respective tasks. A path between processing elements has a unique pair of input and output, to which an ID or a path ID that identifies the path therebetween is assigned. The control unit 11 generates information on the configuration of the processing path (or execution transition information). An example of the execution transition information is shown in FIG. 4. FIG. 4 is a table showing exemplary items of information constituting the execution transition information and exemplary data of the respective items of the information.

The execution transition information includes, for example, ID information including the ID of the service to be executed and path information for processing of the service. The path information has a PE section and a path section. The PE section includes the PEIDs of the processing elements that provide functions and the function IDs. The path section includes the PEIDs of the processing elements that transmit data (or sources) and the PEIDs of the processing elements that receive data (or destinations), and the IDs of the paths (or path ID) between the respective sources and destinations.

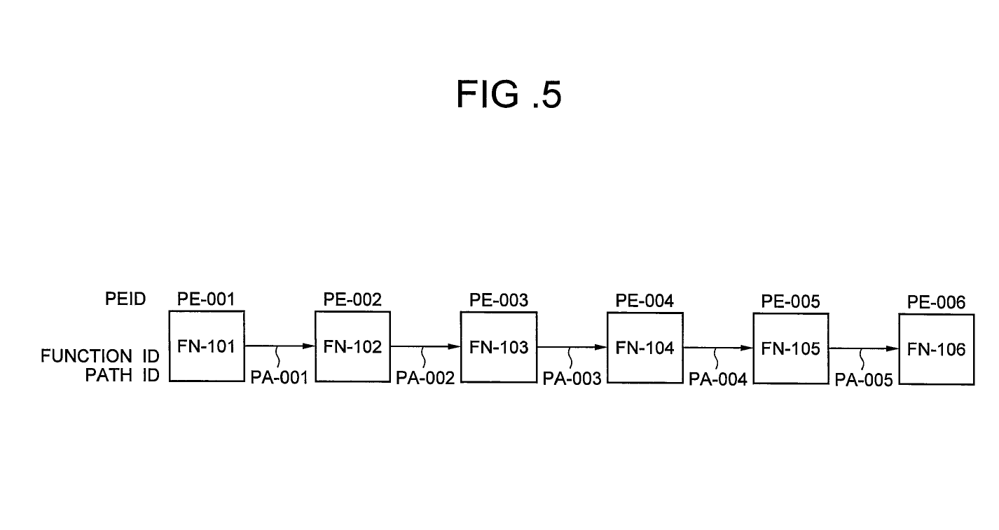

For example, the processing path in performing the JPEG decoding can be configured as shown in FIG. 5 in accordance with the execution transition information shown in FIG. 4. FIG. 5 is a diagram showing an exemplary model of a system corresponding to the configuration specified by the execution transition information shown in FIG. 4.

After the execution transition information is generated, computational resources necessary for the process and processing paths are allocated.

In the following, control function in the distributed processing system according to this embodiment will be described.

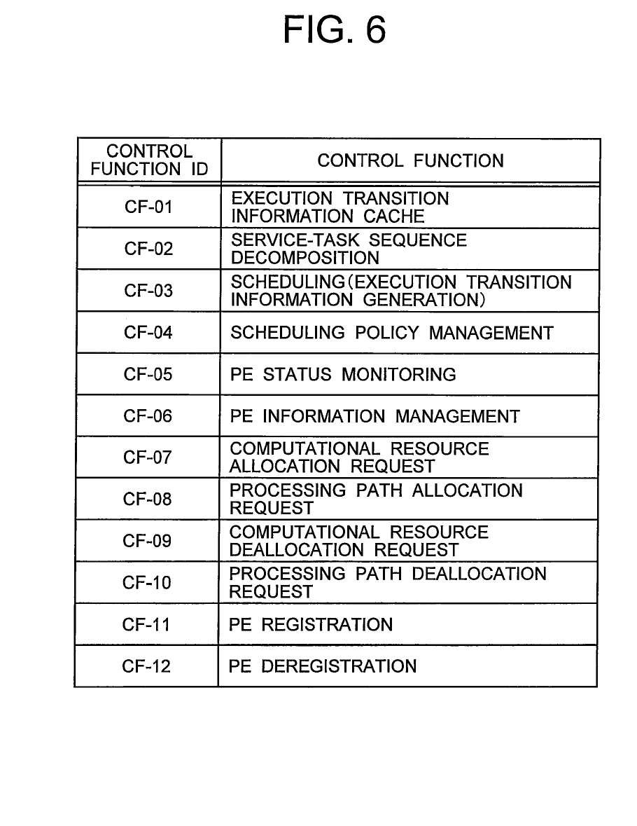

First, the types of the control functions will be described with reference to FIG. 6. FIG. 6 is a table showing examples of the control functions used in the distributed processing system according to this embodiment. FIG. 6 shows control function IDs and the corresponding control functions.

In this system, there are, for example, twelve control functions associated with the corresponding control function IDs CF-01 to CF-12 as shown in FIG. 6.

In the following, each of these control functions will be described.

The “execution transition information cache” associated with the ID of CF-01 is the function of caching the execution transition information locally.

The “service-task sequence decomposition” associated with the ID of CF-02 is the function associating a service with a sequence of one or more consecutive tasks.

The “scheduling (execution transition information generation)” associated with the ID of CF-03 is the function of selecting the most suitable processing elements that have functions of executing tasks necessary for the service according to a scheduling policy and determining the order of execution of the selected processing elements and the input/output connection between the processing elements.

The “scheduling policy management” associated with the ID of CF-04 is the function of managing information, which information management includes disclosure of the scheduling policy or guidelines for generating the execution transition information.

The “PE status monitoring” associated with the ID of CF-05 is the function of obtaining the execution status of the processing element, in particular dynamic information during the execution.

The “PE information management” associated with the ID of CF-06 is the function of managing information, which information management includes disclosure of static information such as the specifications of the processing element.

The “computational resource allocation request” associated with the ID of CF-07 is the function of requesting allocation of computational resources, such as the memory of the processing element, that are needed to execute a task in accordance with the execution transition information.

The “processing path allocation request” associated with the ID of CF-08 is the function of requesting allocation of processing paths between the processing elements and between the processing element and the client in accordance with the execution transition information.

The “computational resource deallocation request” associated with the ID of CF-09 is the function of requesting deallocation of computational resources used in the service processing after completion of the service processing so as to make them available for another service processing.

The “processing path deallocation request” associated with the ID of CF-10 is the function of requesting deallocation of processing paths used in the service processing after completion of the service processing.

The “PE registration” associated with the ID of CF-11 is the function of registering information on the processing element connected to the control unit, such as information on the function of the processing element, at the time of startup of the processing element.

The “PE unregistration” associated with the ID of CF-12 is the function of unregistering the registered processing element by deleting or invalidating the registered information on the processing element.

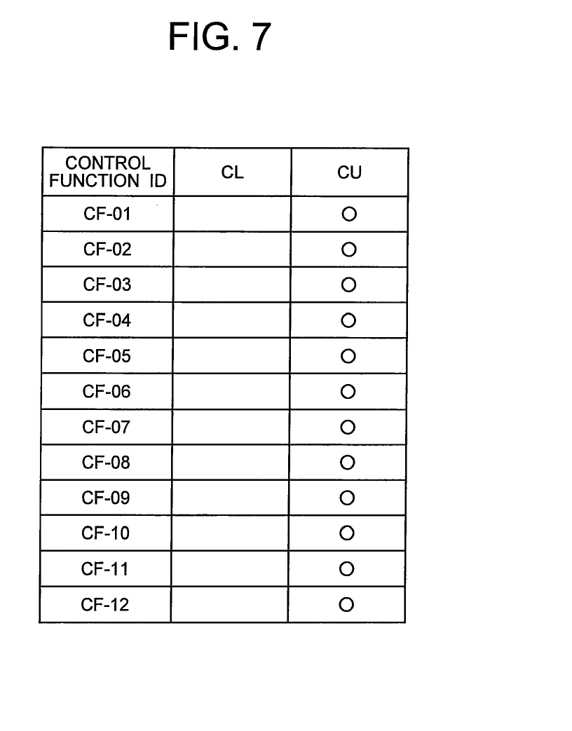

In the following, the selective setting of the control functions will be described with reference to FIGS. 7 to 11.

In the distributed processing system according to this embodiment, the client 21 can also exercise the control functions same as the control unit 11. Namely, the client 21 has all the control functions that the control unit 11 has. Therefore, the control functions can be assigned to one or both of the client and the control unit by selecting the functions assigned to the respective units under the control of the control unit. In the following description, the selective setting of the control functions is presented schematically in tables shown in FIGS. 7 to 11. It should be understood the embodiment is not limited to these settings.

The application of the distributed processing system according to the present invention is not limited to the case where, as with this embodiment, the client 21 has all the control functions that the control unit 11 has, but it can be applied to systems in which a client has at least one of the control functions that the control unit 11 has.

FIG. 7 is a table showing a first example of the selective setting of the control functions. In FIGS. 7 to 11, “CL” represents the client 21, and “CU” represents the control unit 11, and the selected unit (s) (among the client and the control unit) for each function is indicated by a circle.

In the first example of the selective setting, the control unit (CU) is selected for all the control functions, and the control unit 11 performs all the system controls.

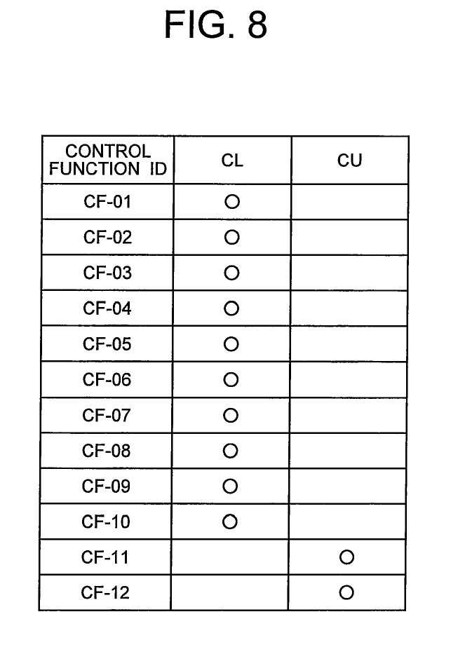

The control unit can change the selective setting to assign some or all of the control functions to the client. For example, as shown in FIG. 8, it is possible to change the assignment of the control functions CF-01 through CF-10 in the selective setting into the client (CL). FIG. 8 is a table showing a second example of the selective setting of the control functions.

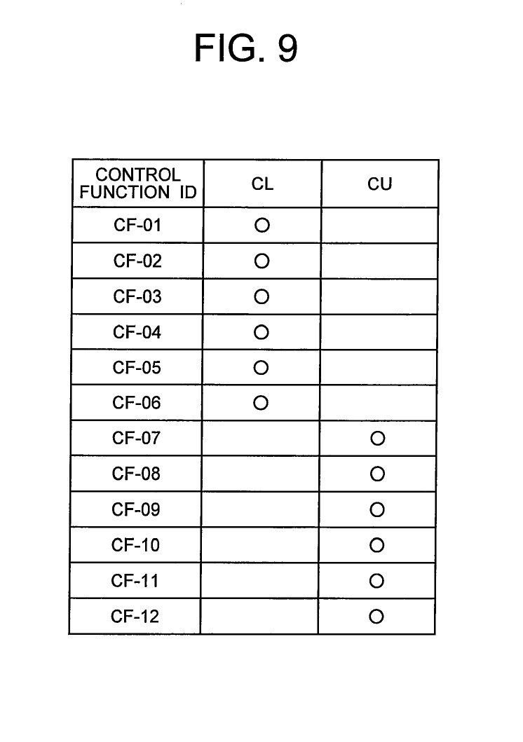

Alternatively, as shown in FIG. 9, it is also possible to change the assignment of the control functions CF-01 through CF-06 in the selective setting into the client (CL). FIG. 9 is a table showing a third example of the selective setting of the control functions.

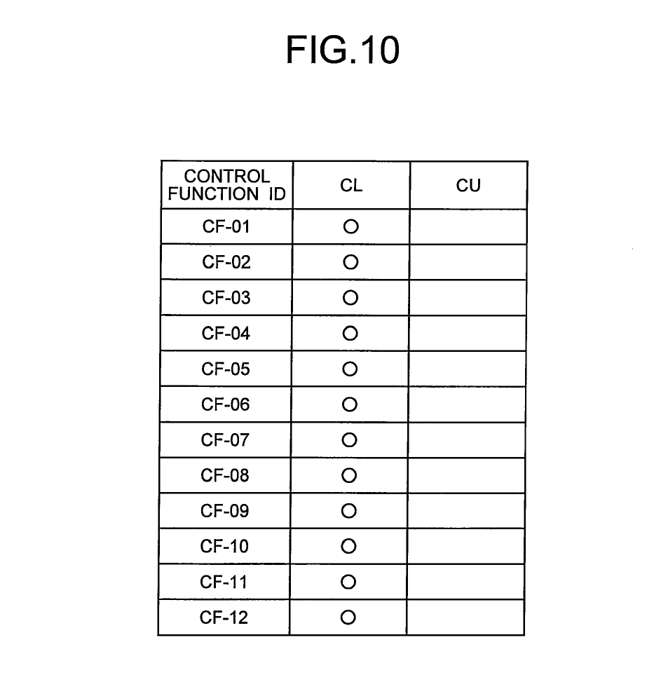

FIG. 10 is a table showing a fourth example of the selective setting of the control functions.

In the fourth example of the selective setting, all the control functions are assigned to the client (CL).

In the above described first to fourth examples of the selective setting, the control functions are alternatively assigned to either the client 21 or the control unit 11. However, some of the control functions may be assigned to both the client 21 and control unit 11.

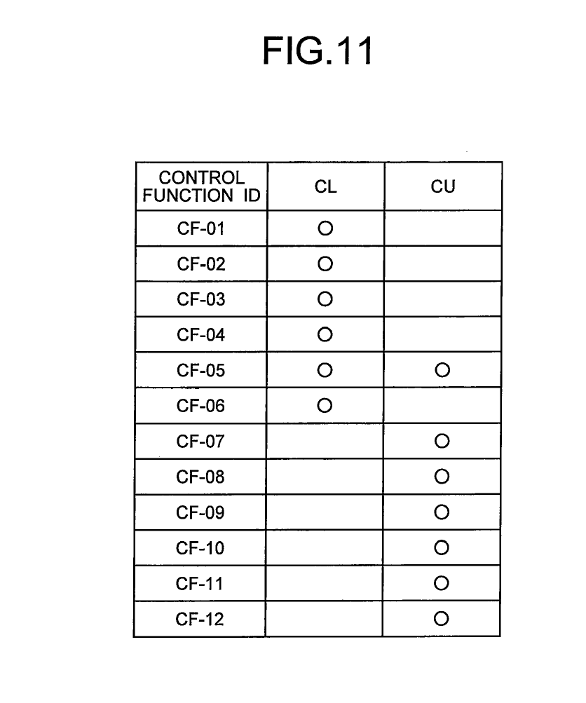

For example, as shown in FIG. 11, as to the control function of PE status monitoring (CF-05), both the client 21 and control unit 11 may monitor a processing element to obtain information. FIG. 11 is a table showing a fifth example of the selective setting of the control functions.

It is preferred that the information management functions such as the control function CF-04 (scheduling policy management) and the control function CF-06 (PE information management) that include disclosure of information necessary for the control functions be used in combination with appropriate control functions (which are, in this case, CF-03 and CF-05). Nevertheless, the control functions CF-03 and CF-04 may be assigned separately to the client 21 and the control unit 11. For example, the client 21 may be configured to perform the control function CF-04 (scheduling policy management), while the control unit 11 is configured to perform the control function CF-03 (scheduling) respectively. In the case of the PE information management also, the control functions CF-05 and CF-06 may be assigned separately to the client 21 and the control unit 11. In some cases, it may be necessary for the client 21 and the control unit 11 to exchange information necessary for the control function with each other.

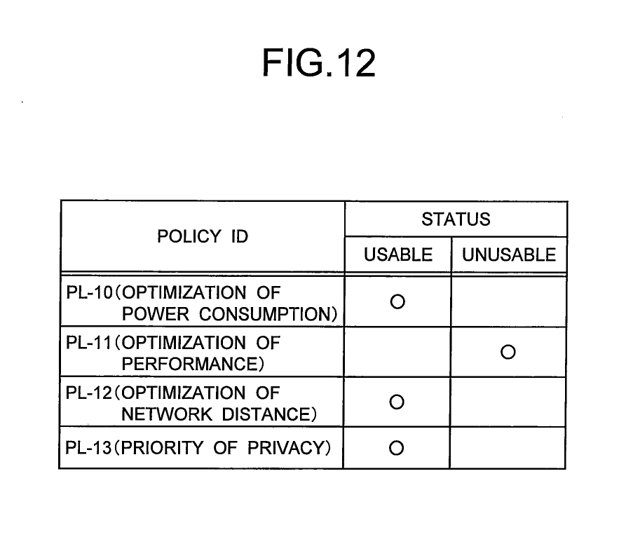

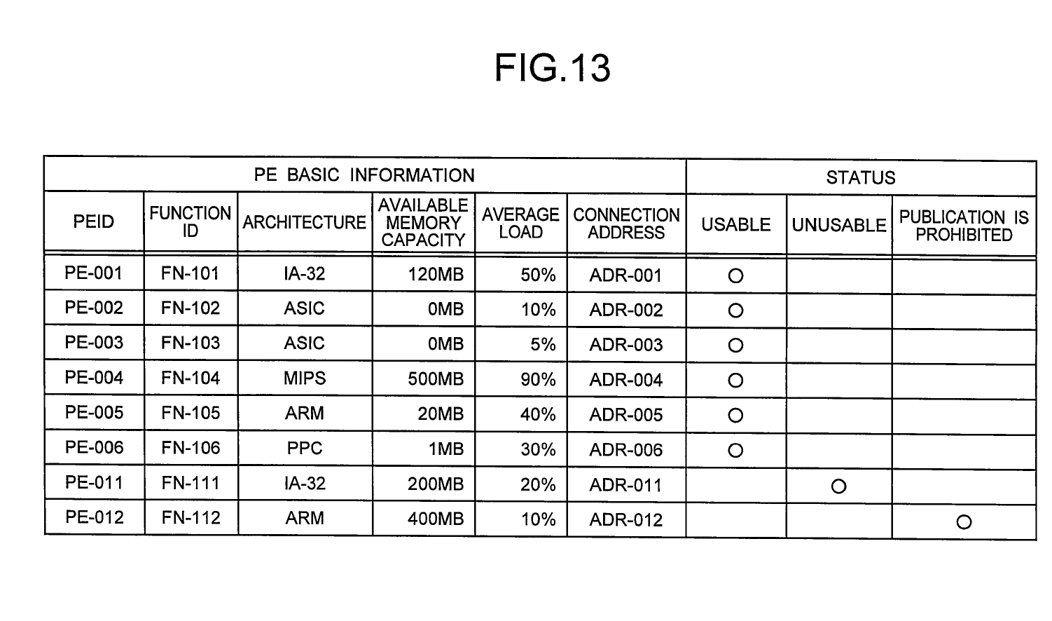

In the following, information necessary for the control function will be described with reference to FIGS. 12 and 13.

Some of the control functions require certain information to work properly. In the case where the control unit 11 assigns, in the selective setting, a certain control function(s) to the client 21, it is necessary to disclose information on the assignment. The control unit 11 may restrict the disclosure of the information partly or entirely. In addition, the control functions include management functions including the function of disclosing information necessary for a control function(s).

In the following, the control functions CF-04 (scheduling policy management) and CF-06 (PE information management) will be described by way of example.

FIG. 12 is a diagram showing examples of policy IDs and their status in the scheduling policy management.

To carry out the control function CF-03 of scheduling, it is necessary to select a scheduling policy serving as the guidelines of scheduling. The control function CF-04 is a scheduling policy management function that manages, for example, disclosure of the list of scheduling policies registered in the system.

In the case discussed herein, the following four policies are provided:

(a) the policy of optimizing power consumption and allocating processing paths that enable the service execution with low power consumption;
(b) the policy of maximizing performance;
(c) the policy of maximizing communication performance between processing elements to optimize the network distance; and
(d) the policy of protecting privacy.
The policies (a), (b), (c), and (d) are identified by the IDs, namely PL-10 (optimization of power consumption), PL-11 (optimization of performance), PL-12 (optimization of network distance), and PL-13 (priority of privacy).

In this case, in order to prevent the overload of the entire system from occurring, the control unit 11 disables the status of the policy PL-11 or the policy of maximizing performance (status=“unusable”), thereby restricting the client 21 from allocating processing path using the policy PL-11. On the other hands, the control unit 11 enables the other three policies (status=“usable”), and provides relevant information (FIG. 12).

FIG. 13 is a table showing an example of the PE basic information and status in the PE information management.

As is the case with the above described scheduling policy management, when performing scheduling (or CF-03), it is necessary to monitor information on the processing elements to be incorporated into the processing path. As information used in the PE information management CF-06, information on the processing elements necessary for scheduling is provided from the processing element(s), for example, in the form of a table, as shown in FIG. 13, containing information on the processing elements at a time before the client 21 is selected in the selective setting.

The information on the processing elements shown in FIG. 13 includes the PEID, the function ID, the architecture of the processing elements, the remaining memory capacity, the average load in the past, and connection address. The information on the processing elements further includes the status of authorization of use. Thus, the status of a processing element to be restricted from being incorporated into the path may be indicated as “unusable”. The control function CF-06 is the function of managing such information on the processing elements.

Information used in the PE information management is not limited to the information shown in FIG. 13, and the form of the information provided as the PE management information is not limited to a table like that shown in FIG. 13.

In some cases, the aforementioned items of information (such as the ID of each processing element and/or the connection address) are needed to enable the control function CF-05 of PE status monitoring. In such cases, it is preferred that the disclosure of the processing element(s) that is (are) to be restricted from being monitored be prohibited so that the disclosure of the information of the processing element(s) can be restricted.

For example, a high-performance processing element(s) may be provided only to the clients 21 that are used by users paying fees higher than a certain amount.

Furthermore, it is preferred that the unusable processing element(s) be allowed to be monitored but not allowed to be incorporated into the processing path. It is also preferred that the processing element(s) that is not allowed to be disclosed be prevented from being monitored or incorporated into the processing path.

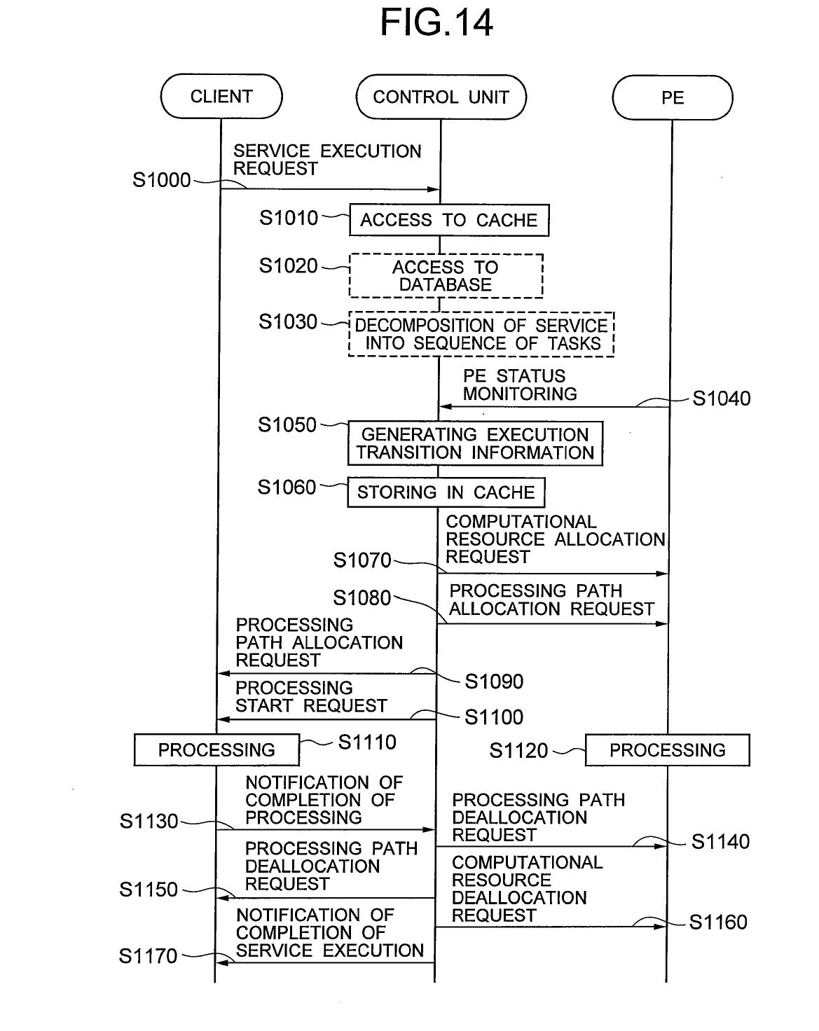

Next, process flows in the distributed processing system according to the embodiment will be described with reference to FIGS. 14 to 16. In FIGS. 14 to 16, “CLIENT” refers to the client 21, “CONTROL UNIT” refers to the control unit 11, and “PE” refers to the relevant processing elements among the PE31 to PE3n.

FIG. 14 is a process flow diagram showing a process in the case all of the control functions are assigned to the control unit 11 in the selective setting. This selective setting in this case corresponds to the selective setting shown in FIG. 7.

In step S1000, the client 21 makes a request for execution of a service to the control unit 11. For example, the client 21 sends a service ID to specify the required service.

In step S1010, the control unit 11 searches the cache in which the execution transition information used in the past is stored for an entry corresponding to the service. If there is a hit in the cache, the process proceeds to step S1040.

If there is no hit in the cache, the control unit 11 accesses, in step S1020, a database in which information on the correspondence between the service and tasks is stored as shown in FIG. 3, and divides the service into a sequence of tasks in step S1030.

In step S1040, the control unit 11 periodically monitors the status of the processing element to keep track of the processing load or the usage rate of the memory as dynamic information. In addition, the control unit 11 has the system configuration information of the processing elements as static information. Although the step of PE status monitoring is provided between step S1030 and step S1050 for the sake of convenience, the control unit 11 may monitor the status of the processing element at any time.

In step S1050, the control unit 11 generates the execution transition information using the scheduling policies taking into account the status of the processing elements.

In step S1060, the execution transition information thus generated is stored in the cache.

After step S1060, the control unit 11 sends a request for computational resource allocation and the execution transition information at the same time to the processing elements that constitute the processing path, in step S1070. The processing elements allocate computational resources such as a memory necessary for the data processing. The execution transition information may be designed to serve as a request for computational resource allocation. Hereinafter, control signals such as a request will be described in distinction from information necessary for the control. However, a distinction between them is not indispensable.

Although the client 21, which is also a kind of processing element, can provides a data processing function, it is assumed, for the sake of simplicity, that the client 21 in this example does not perform data processing but performs only processing for input and output of image data in the JPEG processing. Therefore, a request for computational resource allocation is not made to the client 21.

In steps S1080 and S1090, the control unit 11 makes a request for processing path allocation to each of the processing elements that constitute the processing path and the client 21. Each processing element and the client 21 allocate the processing paths leading to the processing elements adjacent thereto in the processing path.

After the completion of processing path allocation that connects the client 21 and the processing elements, the control unit 11 sends a processing start request to the client 21, in step 1100.

In steps S1110 and S1120, the client 21 and the processing elements perform the processing necessary for execution of the service. Specifically, the first processing element processes the data input from the client, and outputs it to the next processing element along the processing path. The processing and transfer of the data are performed repeatedly from one processing element to another until the last processing element, and lastly the client receives the processing result. The input and output of data performed by the client is not essential, but the input and output of data may be performed by a processing element(s) other than the client in some embodiments.

In step S1130, the client 21 notifies the control unit 11 of the completion of the processing.

In steps S1140 and S1150, the control unit 11 makes a request for deallocation of the processing paths to the processing elements and the client 21 respectively.

In step S1160, the control unit 11 makes a request for deallocation of the computational resources to the processing elements.

In step S1170, the control unit 11 sends a notification of the completion of service execution to the client 21, and terminates execution of the service.

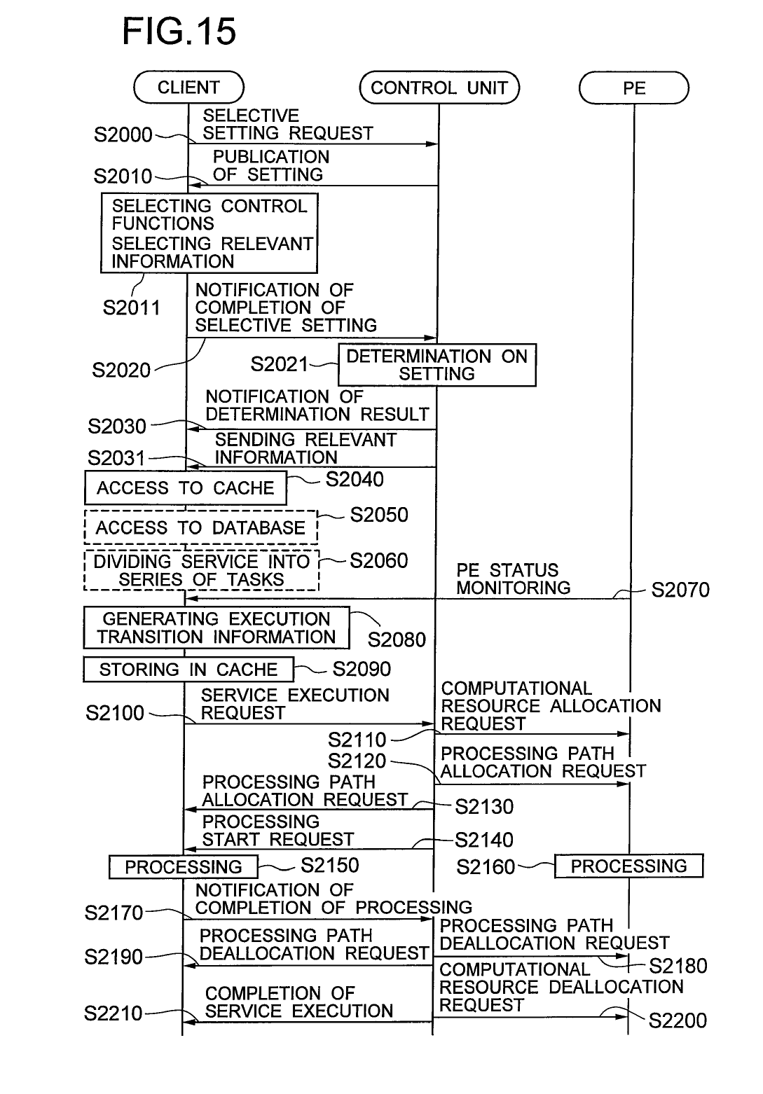

FIG. 15 is a process flow diagram showing a process in the case where some control functions are assigned, in the selective setting, to the client 21, and the other control functions are assigned to the control unit 11.

In step S2000, the client 21 makes a request for selective setting of the control functions to the control unit 11.

In step S2010, the control unit 11 sends to the client 21 selective setting information in which the control functions that can be executed by the client 21 are selected. For example, the control unit 11 determines that the control functions CF-01 to CF-10 shown in FIG. 6 can be or allowed to be executed by the client 21, and sends the information shown in FIG. 8. Together with this, the control unit 11 sends a list of relevant information necessary for the control functions.

In step S2011, the client 21 selects the control functions and the relevant information needed, and updates the selective setting of the control functions, if need be.

In step S2020, the client 21 notifies the control unit 11 of the completion of selective setting and sends the result of selection of the control functions and relevant information. For example, the client 21 selects the control functions CF-01 to CF-06, and sends the information shown in FIG. 9 to the control unit 11. In addition, the client 21 notifies the control unit 11 of, for example, the selection of the relevant information (e.g. scheduling policy PL-10) necessary for the selected control functions. Practically, there may be cases in which the client 21 makes a combined selective setting in which multiple scheduling policies such as PL-10 and PL-13 are selected in combination and notifies the control unit 11 of it.

In step S2021, the control unit 11 determines whether or not the result of the selection meets a criterion. If the selection by the client 21 does not meet the criterion, for example, if the client 21 has selected an unusable function or unusable information or if the client 21 has selected items that cannot be selected at the same time, the control unit 11 rejects the selective setting by the client 21. If the selection made by the client 21 meets the criterion, the control unit 11 accepts the selective setting by the client 21. The criterion for the determination can be provided in the device in advance, for example, at the time of manufacturing or can be set in the control unit 11 by, for example, a request by a user at the time of execution. The “user” in this context is not limited to the user who made the service execution request.

In step S2030, the control unit 11 notifies the client 21 of the result of determination on the selection result. In step S2031, the control unit 11 sends relevant information such as a scheduler to the client 21 as needed. The scheduler is provided, for example, in the form of program modules or information on the interconnections of hardware.

If the selective setting is affirmed, the client 21 executes the control functions CF-01 to CF-06 on behalf of the control unit 11. In step S2040, the client 21 accesses the cached execution transition information in order to generate execution transition information for the service requested by a user. If there is a hit in the cache, the process proceeds to step S2070.

On the other hand, if there is no hit in the cache, the client 21 accesses a database in which information on the correspondence between the service and the sequence of tasks is stored in step S2050, and obtains the sequence of tasks corresponding to the service in step S2060.

In step S2070, the client 21 periodically monitors the status of the processing elements based on the basic information on the processing elements received from the control unit 11. Although the step of PE status monitoring is provided between step S2060 and step S2080 for the sake of convenience, the client 21 may monitor the status of the processing element at any time.

In step S2080, the client 21 generates the execution transition information for the processing elements that are needed to execute the sequence of tasks, based on the status of the processing elements obtained by the monitoring and the scheduling policy.

In step S2090, the client 21 stores the generated execution transition information in the cache.

In step S2100, the client 21 sends a service execution request to the control unit 11 together with the execution transition information thus generated.

In step S2110, the control unit 11 requests, based on the received execution transition information, the processing elements to allocate computational resources such as memory necessary for execution of the service and sends the execution transition information, at the same time. Although the client 21, which also is a kind of processing element, can provide a data processing function, it is assumed, for the sake of simplicity, that the client 21 in this example does not perform data processing but performs only the processing of inputting and outputting image data in the JPEG processing. Therefore, a request for computational resource allocation is not made to the client 21.

In steps S2120 and S2130, the control unit 11 requests each processing element and the client 21 to allocate the processing path leading to the processing elements or the client 21 adjacent thereto in the processing path.

After the completion of processing path allocation, the control unit 11 requests the client 21 to start the processing, in step 2140.

In steps S2150 and S2160, the client 21 and the processing elements perform the input/output processing and data processing. Specifically, the first processing element processes the data input from the client 21, and outputs it to the next processing element along the processing path. The processing and transfer of the data are performed repeatedly from one processing element to another until the last processing element, and lastly the client 21 receives the processing result. The input and output of data performed by the client 21 is not essential, but the input and output of data may be performed by a processing element(s) other than the client 21 in some embodiments.

After completion of the process, the client 21 notifies the control unit 11 of the completion of the processing in step S2170.

In steps S2180 and 2190, the control unit 11 requests the processing elements and the client 21 respectively to deallocate the processing path.

In step S2200, the control unit 11 makes a request for deallocation of the computational resources to the processing elements.

Lastly in step S2210, the control unit 11 sends a notification of the completion of service execution to the client 21.

In the above-described case, the selective setting of the system control requested by the client 21 can be provided in the device in advance, for example, at the time of manufacturing or can be requested, for example, by a user through the client 21 at the time of service execution. The “user” in this context is not limited to the user who made the service execution request.

In the case where the selective setting to be used is known in advance, for example, in the case where the client 21 and control unit 11 use a fixed selective setting, steps S2000 to S2031 may be skipped.

Alternatively, steps S2000 to S2031 shown in FIG. 15 may be inserted before step S1000 shown in FIG. 14, through which the client 21 may make a selective setting request to cause the control unit 11 to execute all the control functions.

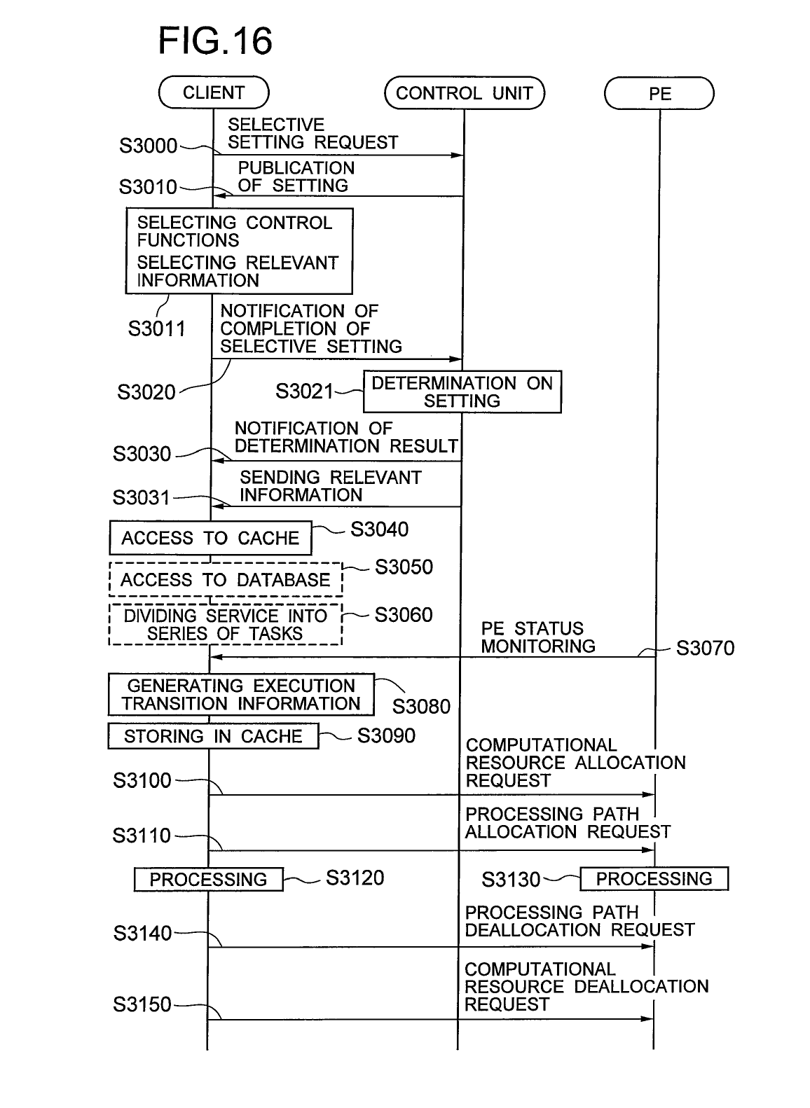

FIG. 16 is a process flow diagram showing a process in the case where all the control functions are assigned to the client 21 in the selective setting. The selective setting of the control functions in this case corresponds to the selective setting shown in FIG. 10.

In step S3000, the client 21 makes a request for selective setting of the control functions to the control unit 11.

In step S3010, the control unit 11 sends to the client 21 selective setting information in which the control functions that can be executed by the client 21 are selected. In this case, the control unit 11 determines that all the control functions can be executed by the client 21, and sends the information shown in FIG. 10. Together with the selective setting information, the control unit 11 sends a list of relevant information needed to exercise the control functions.

In step S3011, the client 21 selects the control functions and the relevant information needed, and updates the selective setting of the control functions, if need be. In this case, the selective setting need not be updated because the selective setting is not changed.

In step S3020, the client 21 notifies the control unit 11 of the completion of selective setting and sends the result of selection of the control functions and relevant information. The client 21 selects all of the usable control functions and returns the information shown in FIG. 10 to the control unit 11.

In step S3021, the control unit 11 determines whether or not the result of the selection meets a criterion. The criterion for the determination can be provided in the device in advance, for example, at the time of manufacturing or can be set in the control unit 11, for example, by a request from a user at the time of execution. The “user” in this context is not limited to the user who made the service execution request.

In step S3030, the control unit 11 notifies the client 21 of the result of determination on the selection result. In step S3031, the control unit 11 sends relevant information such as a scheduler to the client 21 as needed. The scheduler is provided, for example, in the form of program modules or information on the interconnections of hardware.

If the selective setting is approved, the client 21 executes all of the control functions on behalf of the control unit 11. In step S3040, the client 21 accesses the cached execution transition information in order to generate execution transition information for the service requested by a user. If there is a hit in the cache, the process proceeds to step S3070.

If there is no hit in the cache in step S3040, the client 21 accesses the database in which information on the correspondence between the service and the sequence of tasks is stored in step S3050, and obtains the sequence of tasks corresponding to the service in step S3060.

In step S3070, the client 21 periodically monitors the status of the processing elements based on the basic information on the processing elements received from the control unit 11. Although the step of PE status monitoring is provided between step S3060 and step S3080 for the sake of convenience, the client 21 may monitor the status of the processing element at any time.

In step S3080, the client 21 generates the execution transition information for the processing elements that are needed to execute the sequence of tasks, based on the status of the processing elements obtained by the monitoring and the scheduling policy.

In step S3090, the client 21 stores the generated execution transition information in the cache.

In step S3100, the client 21 requests, based on the generated execution transition information, the processing elements that constitute the processing path to allocate computational resources such as memory.

In step S3110, the client 21 requests, based on the generated execution transition information, each of the processing elements that constitute the processing path to allocate the processing path. In this process, the client 21 does not need to make a request to itself but allocates a processing path (s) leading to a processing element(s).

In steps S3120 and S3130, the client 21 and the processing elements perform the input/output processing and data processing necessary for execution of the service, respectively. Specifically, the first processing element processes the data input from the client 21, and outputs it to the next processing element along the processing path. The processing and transfer of the data are performed repeatedly from one processing element to another until the last processing element, and lastly the client 21 receives the processing result. The input and output of data performed by the client 21 is not essential, but the input and output of data may be performed by a processing element(s) other than the client 21 in some embodiments.

In step S3140, the client 21 makes a request for deallocation of the processing paths to the processing elements after the completion of process. At this time, the client 21 deallocates the processing path (s) between the client 21 itself and the processing element(s).

In step S3150, the client 21 makes a request for deallocation of the computational resources to the processing elements. At the end of the service, the client 21 need not to notify any element of the completion of execution of the service, because the execution of the service was requested by the client 21 itself.

In the above-described case, the selective setting of the system control requested by the client 21 can be provided in the device in advance, for example, at the time of manufacturing or can be requested, for example, by a user through the client 21 at the time of execution. The “user” in this context is not limited to the user who made the service execution request.

In the case where the selective setting to be used is known in advance, for example, in the case where the client 21 and control unit 11 use the fixed selective setting, steps S3000 to S3031 may be skipped.

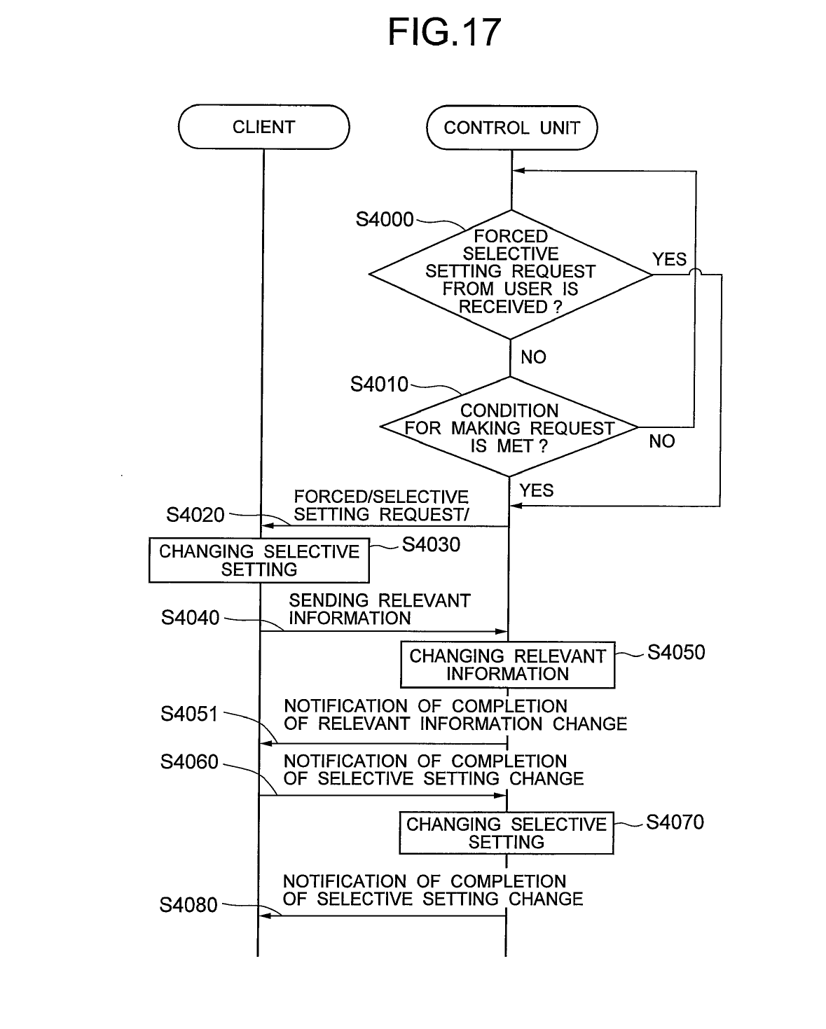

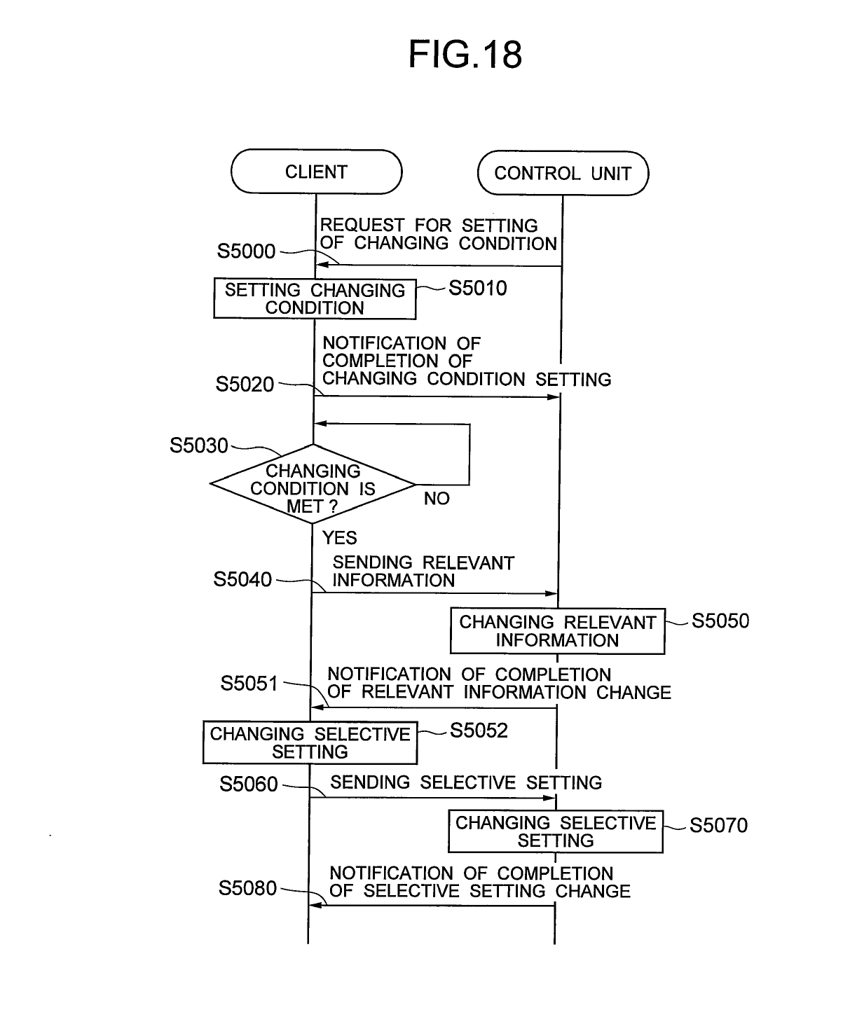

Next, forced change of selection of the control functions will be described with reference to FIGS. 17 and 18.

The control unit 11 can forcibly change the selective setting in the client 21 as needed in order to manage the entire system efficiently and orderly.

The forced change of selection includes the following two cases:

(A) taking back the assignment of a control function(s) from the client 21; and
(B) forcibly assigning a control function(s) to the client 21.

The methods of forced change of selection include:

(1) changing the selective setting by a control command generated by the control unit 11; and
(2) setting a condition for changing beforehand and changing the selective setting when the condition is met.

The control command may be generated either in response to a request by a user or automatically when a condition for generating the command is met. For example, in the case where it is desirable that the control functions be distributed forcibly when the processing load on the control unit 11 is high, the condition for generating the command may be “when the processing load of the control unit CU 11 exceeds 60%, the control functions CF-07 through CF-10 in the selective setting be forcibly assigned to the client 21”. The “user” in this context is not limited to the user who made the service execution request.

It is preferred that the forced change of selection be determined comprehensively taking into account the processing load on the client 21 at the time of use and the history of the forced change of selection performed in the past.

The condition for generating the command can be provided in the device in advance, for example, at the time of manufacturing or can be set by the control unit 11, for example, in response to a request by a user at the time of execution. The “user” in this context is not limited to the user who made the service execution request. Examples of the condition for generating the command include:

(1) the time elapsed since the selection of the control functions of the client 21 was made;
(2) the condition of a service execution environment, e.g. a voltage drop caused by power failure during the service execution;
(3) the state of service execution load, e.g. the CPU load;
(4) the state of computational resource usage, e.g. the remaining memory capacity; and
(5) the status of service execution, e.g. upon the completion of service execution.

The control unit 21 can take back the assignment of the control functions to the client 21 or assign additional control functions to the client 21 according to the above conditions (1) to (5).

When any of the above conditions is met, if the forced change of selection from the client 21 according to a changing condition (i.e. a condition for changing the selective setting) and a control command or a change of the conditions for changing the selection made by the control unit 11 conflict with each other, it is preferred that the priority be placed on the command from the control unit 11 and the control unit 11 always have a priority in the system control.

Next, a flow of forced change of selection made by a control command will be described with reference to FIG. 17. FIG. 17 is a flow chart showing the flow of forced change of selection made by the control command.

In step S4000, the control unit 11 checks whether or not it has received a forced selective setting request (i.e. a request for forced selection of a control function(s)) from a user. This user is not limited to the user who made the service execution request. If the control unit 11 has received the forced selective setting request (YES in step S4000), the process proceeds to step S4020.

If the control unit 11 has not received the forced selective setting request (NO in step S4000), the control unit 11 determines, in step S4010, whether or not a condition for making a forced selective setting request is met. If it is determined that the condition for making the request is not met (NO in step S4010), the process returns to step S4000. The order of steps S4000 and S4010 may be arbitrary changed, and the illustrated order is not intended to specify a particular priority between them. It is assumed that the control unit 11 can make the determinations in steps S4000 and S4010 while concurrently executing other functions.

If the control unit 11 has received the forced selective setting request from a user (YES in step S4000), or if the condition for making a forced selective setting request is met (YES in step S4010), the control unit 11 makes, in step S4020, a forced selective setting request to the client 21.

In the case, for example, where the forced selective setting request requires that the control unit 11 take back the assignment of all the control functions, the control unit 11 sends the selective setting shown in FIG. 7 as information attached to the forced selective setting request to the client 21.

In step S4030, the client 21 forcibly changes the selective setting in response to the forced selective setting request sent to it.

In step S4040, the client 21 sends the up-to-date relevant information to the control unit 11 as needed.

In step S4050, the control unit 11 changes the relevant information. In step S4051, the control unit 11 notifies the client 21 of the completion of the change of the relevant information.

Subsequently in step S4060, the client 21 notifies the control unit 11 of the completion of the change of the selective setting.

In step S4070, the control unit 11 changes the selective setting of the control functions.

Lastly, in step S4080, the control unit 11 notifies the client 21 of the completion of the change of the selective setting.

In the following, the forced change of selection according to a changing condition will be described with reference to FIG. 18. FIG. 18 is a flow chart showing a flow of the forced change of selection according to a changing condition.

In step S5000, the control unit 11 sends a changing condition setting request to the client 21.

In response to the request, the client 21 sets a changing condition and stores it, in step S5010.

Subsequently in step S5020, the client 21 notifies the control unit 11 of the completion of setting of the changing condition.

In step S5030, the client 21 determines whether or not the changing condition is met. If the client 21 determines that the changing condition is not met (NO in step S5030), the selective setting is maintained unchanged until the changing condition is met. It is assumed that the client 21 can perform the determination in step S5030 while concurrently executing other functions.

If the client 21 determines that the changing condition is met (YES in step S5030), the client 21 sends information, if any, relevant to the control function(s) for which the change is made to the control unit 11.

Upon receiving the relevant information, the control unit 11 changes the relevant information, in step S5050. In step S5051, the control unit 11 notifies the client 21 of the completion of the change of the relevant information.

Upon receiving the completion of the change of the relevant information, the client 21 changes the selective setting in the client 21, in step S5052.

Subsequently in step S5060, the client 21 sends the changed selective setting to the control unit 11.

Upon receiving the selective setting, the control unit 11 changes the selective setting, in step S5070.

After the completion of the change of the selective setting, the control unit 11 notifies the client 21 of the completion of the change of the selective setting, in step S5080.

The changing condition (s) can be provided in the device that serves as the client 21 in advance, for example, at the time of manufacturing. If this is the case, steps S5000 to S5020 of the above process are not needed.

In the following, modifications of the embodiment will be described.

The above described distributed processing system according to the embodiment includes the control unit 11, the client 21, and the processing elements 31 to 3n. Alternatively, the distributed processing system may be composed of: (1) a client that makes a request for execution of a service requested by a user; and (2) processing elements that are connected to the client mentioned in (1), and the distributed processing system may be controlled only by the control functions provided by the client mentioned in (1).

Still alternatively, the distributed processing system may be composed of: (a) a control unit having the function of accepting the entry of a service request by a user; (b) processing elements that are connected to the control unit mentioned in (a), and the distributed processing system may be controlled only by the control functions provided by the control unit mentioned in (a).

In this system, the control unit is configured to have the function of receiving a service request, and the system can be constructed without a client.

In the distributed processing system, the control unit, and the processing element(s) according to the above described embodiment and modifications, control functions can be assigned to the client, and control information such as PE connection information can be transferred from the control unit to the client to enable processing.

Thus, it is possible to execute an application individually with a decreased CPU load. In conventional systems, when the control unit allocates computational resources and processing paths, the control unit has to send to the client a completion notice upon completion of allocation. In contrast, in the system according to the present invention, the control unit need not to send a completion notice, because the allocation of computational resources and processing paths is executed by the client 21.

Furthermore, it is possible to cause a plurality of clients 21 to operate in cooperation in compliance with the security rules by restricting the range of disclosure of PE connection information and the applicable scheduling policies, to the client 21.

As described in the foregoing, the distributed processing system, the control unit, and the client according to the present invention can suitably be applied to a distributed processing system in which the load of control functions tends to concentrate on the control unit.

The distributed processing system, the control unit, and the client according to the present invention are advantageous in that the concentration of load of the control functions can be prevented from occurring by distributing the system control functions to the control unit and the client, and that a user can flexibly configure the setting for control functions by assigning, by the distribution, a setting operation concerning the control functions to the client.

What is claimed is:

1. A distributed processing system comprising:
a client that makes a request for execution of a service requested by a user;
a processing element;
a control unit connected with the client and the processing element, wherein
the control unit has control functions for controlling the distributed processing system,
the client has at least one control function that is same as one of the control functions of the control unit, and
with respect to at least one control function that both the control unit and the client have, at least one of the control function of the control unit and the control function of the client are used to execute the control.

2. The distributed processing system according to claim 1, wherein with respect to at least one control function that both the control unit and the client have, one of the control function of the control unit and the control function of the client is alternatively selected to execute the control.

3. The distributed processing system according to claim 1, wherein with respect to at least one control function that both the control unit and the client have, both the control function of the control unit and the control function of the client are used to execute the control.

4. The distributed processing system according to claim 1, wherein the selection between the control function of the control unit and the control function of the client is executed by the control unit in accordance with a selective setting that has been stored in the control unit in advance.

5. The distributed processing system according to claim 1, wherein the selection between the control function of the control unit and the control function of the client is executed by the control unit in accordance with a request by the user who requests execution of the service through the client or by another user.

6. The distributed processing system according to claim 1, wherein the control unit makes a determination as to whether execution of the selection of the control function is to be approved or refused according to a criterion, and puts the selection of the control function into practice based on the result of the determination.

7. The distributed processing system according to claim 6, wherein the criterion has been stored in the control unit in advance.

8. The distributed processing system according to claim 6, wherein the control unit sets the criterion in accordance with a request by the user who requests execution of the service through the client or by another user.

9. The distributed processing system according to claim 1, wherein even when the control function of the client is selected, the control unit can send a control command to the client to forcibly select the corresponding control function of the control unit itself instead of the selected control function.

10. The distributed processing system according to claim 1, wherein the control unit can send a control command to the client to forcibly change the control function of the client regardless of whether or not the control function of the client is selected.

11. The distributed processing system according to claim 9, wherein the control unit sends the control command to the client in accordance with a request by the user who requests execution of the service through the client or by another user.

12. The distributed processing system according to claim 9, wherein the control unit sends the control command to the client automatically according to a condition for sending the control command.

13. The distributed processing system according to claim 1, wherein the client forcibly changes, according to a changing condition, a control function that is designated by the changing condition regardless of whether or not the control function of the client is selected, and notifies the control unit of the change.

14. The distributed processing system according to claim 13, wherein the changing condition is set by the control unit when the control function of the client is selected, or has been stored in advance.

15. The distributed processing system according to claim 13, wherein when the notification by the client is made, the control unit sets its own control function again in accordance with the notification.

16. The distributed processing system according to claim 13, wherein the changing condition includes at least one of the elapsed time since the selection of the control function of the client, condition of a service environment, state of service execution load, state of computational resource usage, and status of service execution.

17. The distributed processing system according to claim 1, wherein the control functions include a function of alternatively selecting disclosure or non-disclosure of information necessary for the control function.

18. The distributed processing system according to claim 17, wherein the information of which the disclosure can be restricted includes the status of the processing element.

19. The distributed processing system according to claim 17, wherein the information of which the disclosure can be restricted includes a scheduling policy.

20. The distributed processing system according to claim 1, wherein the control functions include at least one of allocation/deallocation of computational resources, allocation/deallocation of a processing path, monitoring of the status of the processing element, scheduling of processing, selection of a scheduling policy concerning the scheduling, division of a service into tasks, registration/deregistration of the processing element, and storing of path information.

21. The distributed processing system according to claim 1, wherein the client has the control functions same as all of the control functions of the control unit.

22. The distributed processing system according to claim 21, wherein only the control functions of the client are used for all the control functions of the control unit to execute the control.

23. The distributed processing system according to claim 21, wherein only the control functions of the control unit are used for all the control functions of the control unit to execute the control.

24. A distributed processing system comprising:
a client that makes a request for execution of a service requested by a user; and
a processing element connected with the client,
wherein the distributed processing system is controlled only by a control function that the client has.

25. A distributed processing system comprising:
a control unit having a function of accepting the entry of a service request by a user; and
a processing element connected with the control unit,
wherein the distributed processing system is controlled only by a control function that the control unit has.

26. A control unit that constitutes a distributed processing system together with a client that makes a request for execution of a service requested by a user and a processing element, and has control functions for controlling the distributed processing system, wherein with respect to at least one of control functions that both the control unit and the client have, at least one of the control function of the control unit and the control function of the client is selected to execute a control.

27. A client that is connected to a control unit having control functions for controlling a distributed processing system, makes a request for execution of a service requested by a user, and has at least one control function that is same as one of the control functions of the control unit, wherein a control is executed using a control function selected by the control unit with respect to at least one control function that both the control unit and the client have.
